(19) United States
(12) Patent Application Publication
(10) Pub. No.: US 2025/0100065 A1
(43) Pub. Date: Mar. 27, 2025

(54) Contact Tips for Wire Arc Additive Manufacturing

(71) Applicant: Relativity Space, Inc., Long Beach, CA (US)

(72) Inventors: Justin Gray, Long Beach, CA (US); Thomas Gaume, Long Beach, CA (US); Gregory Nicholas Oden, Long Beach, CA (US)

(73) Assignee: Relativity Space, Inc., Long Beach, CA (US)

(21) Appl. No.: 18/825,885

(22) Filed: Sep. 5, 2024

Related U.S. Application Data
(60) Provisional application No. 63/585,124, filed on Sep. 25, 2023.

(51) Int. Cl. B23K 9/26; B23K 9/04; B23K 9/133; B33Y 40/00

(52) U.S. Cl. CPC B23K 9/26; B23K 9/04; B23K 9/133; B33Y 40/00

(57) ABSTRACT

Contact tips for a wire arc additive manufacturing (WAAM) system can include guide portions. Guide portions can include elongated portions with a first end and a second end; guide terminal parts attached to the first end of the elongated portion with terminal grooves. Terminal grooves can be formed between two protrusions. Terminal grooves can be configured to accommodate WAAM wires. Contact tips can further include inset portions. Inset portions can be configured to nest within the guide portion to hold the WAAM wire. When the inset portion is nested within the guide portion there can be a gap between the guide portion and the inset portion such that wire shavings generated during WAAM can be discharged.

### CROSS-REFERENCE TO RELATED APPLICATIONS

The current application claims the benefit, under 35 U.S.C. § 119 (e), of U.S. Provisional Patent Application No. 63/585,124 entitled “Wire Holding Open-Tipped Contact Tips for Wire Arc Additive Manufacturing” filed Sep. 25, 2023. The disclosure of U.S. Provisional Patent Application No. 63/585,124 is hereby incorporated by reference in its entirety for all purposes.

### FIELD OF THE INVENTION

This invention generally relates to additive manufacturing equipment that uses wire feedstock. In particular, it relates to a contact tip for holding a wire for additive manufacturing.

### BACKGROUND

Additive manufacturing is a process by which a product or part is manufactured by adding one layer of material on top of another in a sequence or pattern to generate a solid part. This method of manufacturing is also referred to as three dimensional or 3-D printing and can be done with different materials, including plastic and metal.

3-D printing of metallic structures can involve using an energy source to create a weld pool and feeding a metal wire feedstock into the weld pool by way of a printing head or printing head nozzle. Wire arc additive manufacturing (WAAM) is an example of a technology that uses this 3-D printing method to generate parts from a wire feedstock. In WAAM and other wire-based directed energy deposition (DED) 3D printing methods, the wire feedstock is, more specifically, advanced through a contact tip mounted in a printing head while the wire is melted and deposited on a deposition site. The deposition site can be moved relative to the part as the part is generated. In such a process an arc can form between an advancing wire and a work piece.

The interior of a contact tip can build up significant amounts of material over time, even within a few hours. Such material includes metal shavings that may eject from the wire as it moves through and is abraded by the contact tip. Such material also includes spatter and other unwanted material.

### BRIEF SUMMARY

Systems and methods for contact tips for feeding wires in additive manufacturing are described.

Some embodiments include a contact tip for an additive manufacturing system, the contact tip comprising: a guide portion, wherein the guide portion comprises: an elongated portion with a first end and a second end; and a guide terminal part attached to the first end of the elongated portion with a terminal groove, wherein the terminal groove is formed between two protrusions, and wherein the terminal groove is configured to accommodate a wire; and an inset portion, wherein the inset portion is configured to nest within the guide portion to hold the wire, wherein, when the inset portion is nested within the guide portion, there is a gap between a terminal end of the guide portion and a terminal end of the inset portion such that a material buildup inside the contact tip discharges through the gap.

In some embodiments, the gap has at least one dimension equal to or greater than 3 mm.

In some embodiments, the elongated portion has reduced heights on at least a portion of a first side and a second side such that when the inset portion is nested within the guide portion, there is a second gap and a third gap between the guide portion and the inset portion on the first side and the second side respectively, wherein the second gap and the third gap are configured to discharge the material buildup inside the contact tip.

In some embodiments, at least a portion of the inset portion is coated with a ceramic material.

In some embodiments, at least a portion of the guide portion is coated with a ceramic material.

In some embodiments, at least a portion of the inset portion and at least a portion of the guide portion each is coated with a ceramic material.

In some embodiments, the ceramic material comprises boron nitride.

In some embodiments, the elongated portion has at least one cutout, wherein the at least one cutout is configured to discharge the material buildup inside the contact tip.

In some embodiments, the material buildup inside the contact tip comprises at least one of: a plurality of wire shavings, a molten wire splatter.

In some embodiments, the contact tip is configured to couple with a weld torch, a metal inert gas (MIG) torch, or a tungsten inert gas (TIG) torch.

In some embodiments, the wire aligns coaxially with the terminal groove.

In some embodiments, the contact tip comprises a material of a higher melting temperature than the wire.

In some embodiments, the contact tip is configured to print a part continuously for at least 3 hours.

In some embodiments, the part has at least one dimension of 0.55 inch and printing the part occurs continuously from 3 hours to 6 hours; or wherein the part has at least one dimension of 0.3 inch and printing the part occurs continuously from 6 hours to 8 hours.

Some embodiments include a contact tip for feeding a wire, the contact tip comprising: a first opening for admitting the wire into the contact tip, wherein the first opening lays along a longitudinal axis that is coaxial with a wire path of the wire; a second opening for emitting a first portion of the wire from the contact tip, wherein the second opening lays along the longitudinal axis that is coaxial with the wire path of the wire; and a third opening for emitting a second portion of the wire from the contact tip, wherein the third opening is set apart from the longitudinal axis that is coaxial with the wire path of the wire.

Some embodiments further comprising a fourth opening for emitting a third portion of the wire from the contact tip, wherein the fourth opening is set apart from the longitudinal axis that is coaxial with the wire path of the wire.

In some embodiments, at least a portion of the contact tip comprises a ceramic coating.

In some embodiments, the second portion of the wire comprises a plurality of wire shavings.

Some embodiments include a contact tip for feeding a wire, the contact tip comprising: a first opening for admitting the wire into the contact tip, wherein the first opening lays along a longitudinal axis that is coaxial with a wire path of the wire; and a second opening for emitting the wire and a plurality of wire shavings of the wire from the contact tip, wherein a first wire-emitting region of the second opening lays along the longitudinal axis that is coaxial with the wire path of the wire, and wherein a second wire shavings-emitting region of the second opening is set apart from the longitudinal axis that is coaxial with the wire path of the wire.

Some embodiments further comprising a third opening for emitting the plurality of wire shavings of the wire from the contact tip, wherein the third opening is set apart from the longitudinal axis that is coaxial with the wire path of the wire.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art based on the teachings contained herein.

### BRIEF DESCRIPTION OF THE DRAWINGS

The description and claims will be more fully understood with reference to the following figures and data graphs, which include example embodiments of the invention and should not be construed as a complete recitation of the scope of the invention.

FIG. 1A depicts a legacy clamshell contact tip in an assembled configuration in accordance with prior art.

FIG. 1B depicts a legacy contact tip holding a wire for WAAM in accordance with prior art.

FIGS. 2A through 2C depict material build up in legacy clamshell contact tips.

FIG. 3 depicts a boron nitride coated contact tip in accordance with an embodiment.

FIGS. 4A through 4D depict two views of an open-tipped clamshell contact tip with an open end and side portions in accordance with an embodiment.

FIG. 5A depicts an open-tipped clamshell contact tip with a single face open end in accordance with an embodiment.

FIG. 5B depicts an open-tipped clamshell contact tip in an assembled configuration in accordance with an embodiment.

FIGS. 6A and 6B depict two views of an open-tipped clamshell contact tip with two open faces at an end in accordance with an embodiment.

FIG. 7 depicts a contact tip in accordance with an embodiment.

### DETAILED DESCRIPTIONS

Wire based additive manufacturing such as wire arc additive manufacturing (WAAM) implements a print nozzle to deposit molten materials onto a substrate to form a printed part. A contact tip can be mounted in the print nozzle. The contact tip can hold a feed wire. The feed wire can be advanced through the contact tip during print processes while an electrical connection is maintained between the contact tip and the feed wire. Legacy contact tips are designed for use in welding. The inventors discovered that such legacy contact tips may not be used continuously for a prolonged period of time (such as longer than about 3 hours). When used continuously for over about 4 hours, legacy contact tips can have obvious material build up inside the tips. The inventors realized that build-up materials inside the contact tips can inhibit their ability to conduct current as efficiently as the contact tips without any build up. As a result, the inventors observed that such contact tips may fall apart and fail when used in long-duration WAAM processes.

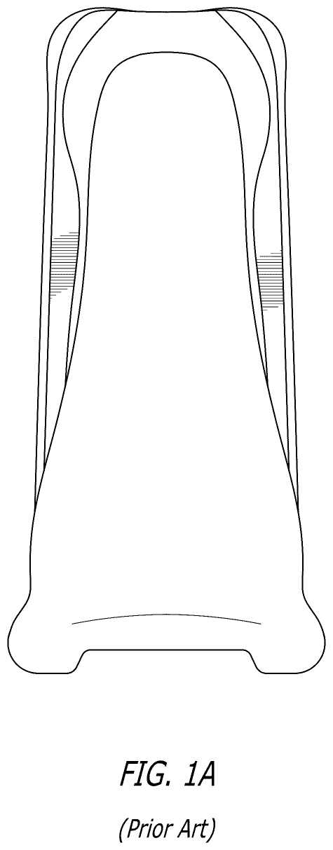

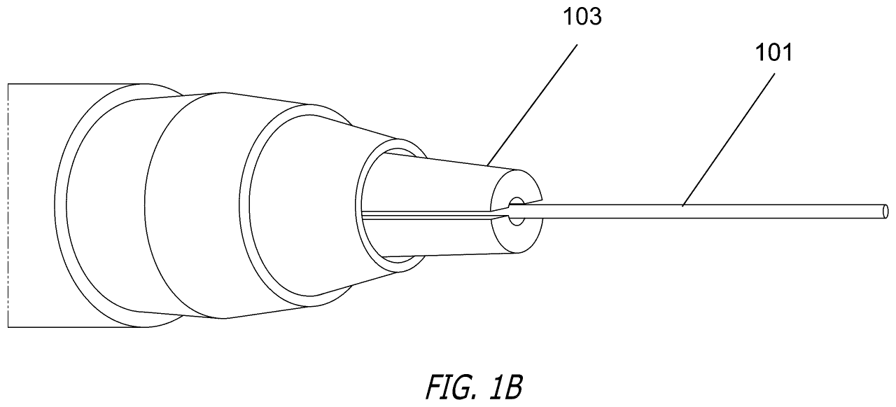

FIG. 1A illustrates a legacy clamshell contact tip. The clamshell contact tip can include two parts assembled together. FIG. 1B illustrates a print head holding a legacy contact tip. A feed wire 101 is fed through the contact tip 103. A groove inside the contact tip can guide the wire through the contact tip. The two parts of the contact tip have almost the same length.

Contact tips can fail because of burnback. Burnback is an undesirable process that occurs because of the metal inert gas (MIG) wire burning back to the contact tip. This often happens when the wire arcs at the contact tip and welds itself inside the tip. Burnback can occur when the contact tip has a poor electrical attachment to the wire. Poor electrical connections can be caused by a poor mechanical connection.

The inventors theorize that legacy clamshell tips fail because of wire shavings building up over the course of a print. The inventors believe that, as wire shavings and other materials accumulate in the contact tip, the two halves of the contact tip begin to separate. Gradually the wire shavings can push a legacy clamshell contact tip apart, and the two halves lose healthy and consistent physical contact with the wire. The inventors believe that this loss of contact causes micro-arcing inside of the tip. Additionally, some commercial welding power supplies are designed to correct automatically for inconsistency in current delivery. Rather than solving the problem, however, the automatic correction causes the arc to become unstable. Thus, the inventors theorize that, as the clamshell contact tip gets pushed apart, it can increase the likelihood of burnback, and therefore a failure.

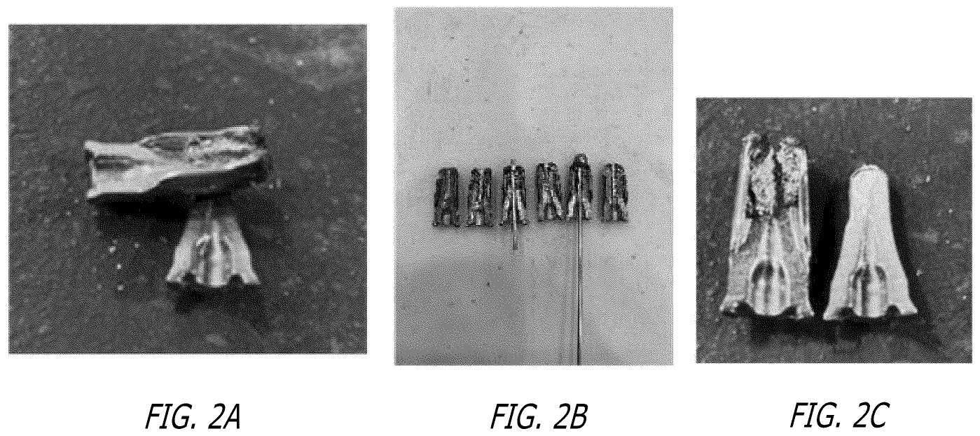

FIGS. 2A through 2C illustrate material build up inside legacy clamshell contact tips in accordance with an embodiment. These legacy contact tips are not designed to be used continuously for a long time. After being used for WAAM processes of fewer than about 4 hours, the contact tips in FIGS. 2A, 2B and 2C all failed. The contact tips in FIGS. 2A, 2B and 2C, each show build-up of materials near the tips from the feed wire.

WAAM processes for industrial scale print parts may need continuous print time that lasts hours. (See, e.g., U.S. patent application Ser. No. 18/352,992 filed Jul. 14, 2023, the disclosure of which is incorporated by reference.) WAAM printers may need frequent change of legacy contact tips to ensure print quality. In addition, WAAM systems can include a plurality of printers. Changing failed contact tips every few hours undesirably increases equipment downtime. The inventors realize that improved designs of contact tips can extend their lifetimes and be suitable for additive manufacturing processes. Many embodiments described below implement improved contact tips to reduce material buildups and extend print time. In some embodiments, the improved contact tips implement coatings to reduce material buildups in the tips. In some embodiments, the improved contact tips have optimized geometries to facilitate removal of material buildups in the tips. In several embodiments, the improved contact tips have optimized geometries and implement coatings to reduce buildups inside the tips.

In several embodiments, open-tipped contact tips can reduce incidence of wire shavings buildup and/or burnback, thereby increasing uptime of WAAM systems. In some embodiments, contact tips with a clamshell configuration can include openings on the contact tip that allow wire shavings to fall through the openings. This can beneficially reduce burnback. The contact tips in accordance with many embodiments can maintain print quality and have print lifetime of at least about 8 hours; or at least about 10 hours; or at least about 15 hours; or from about 8 hours to about 18 hours. Certain embodiments encompass even longer print lifetimes.

In many embodiments, the contact tips can be made with various metallic materials. The metallic materials of the contact tips may have a higher melting temperature compared to the materials of the feed wires. Examples of the metallic materials of the contact tips include (but are not limited to) copper and/or copper alloys.

In several embodiments, contact tips can specially be coated with various types of ceramic materials. Examples of the ceramic coating materials include (but are not limited to) boron nitride, and/or another ceramic coating. Boron nitride can, in several embodiments, be beneficial for reducing the volume of material buildup in contact tips during WAAM processes. Contact tips can, in accordance with several embodiments of the invention, be geometrically configured to reduce undesirable arcing and/or increase cleanability so as to improve longevity of the contact tips. Some embodiments of contact tips can experience close to zero buildup and have lifetimes greater than or equal to about 8 hours.

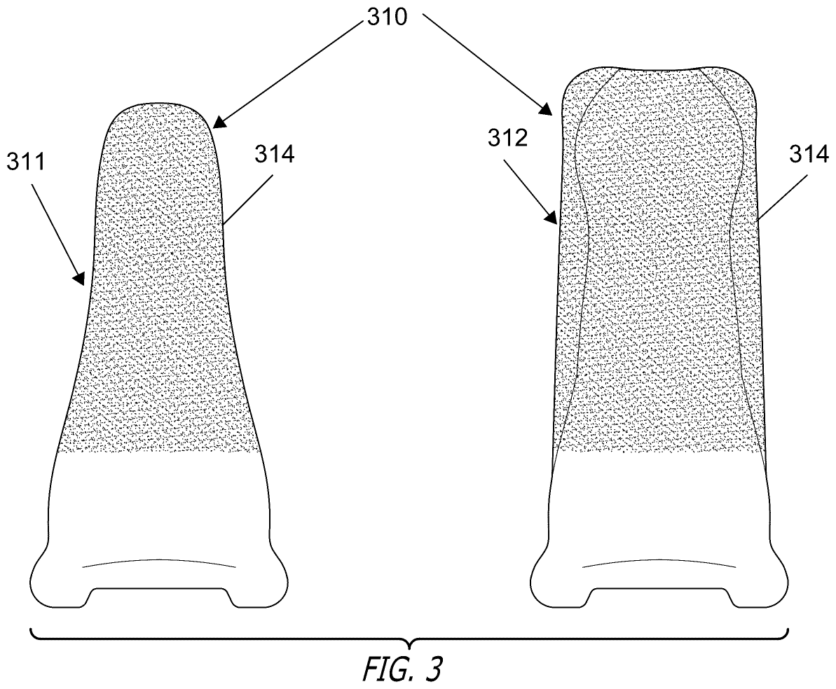

In many embodiments, coatings can be applied to one half and/or both halves of a clamshell contact tip. The coatings can cover the areas where material buildups are likely to accumulate in the contact tip. A boron nitride coated contact tip is depicted in FIG. 3 in accordance with an embodiment. A coating can, in several embodiments, improve the longevity of contact tips used in WAAM processes as further described elsewhere herein. FIG. 3 shows two halves 311 and 312 of a clamshell contact tip 310. Ceramic coatings 314 can be applied to both halves 311 and 312 of the contact tip 310. The ceramic coatings 314 do not need to cover the full length of each of the halves, but cover the areas where materials buildups are likely to occur.

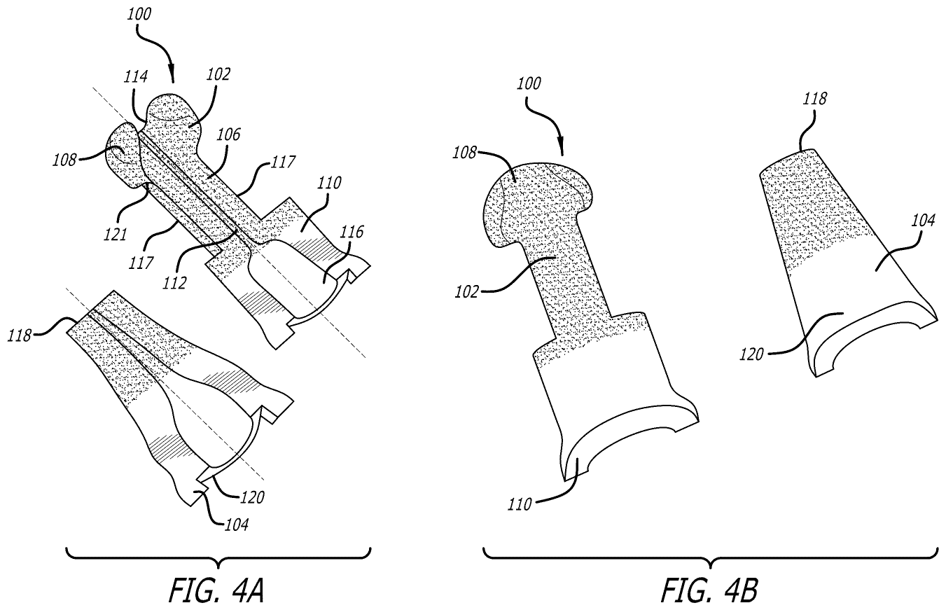

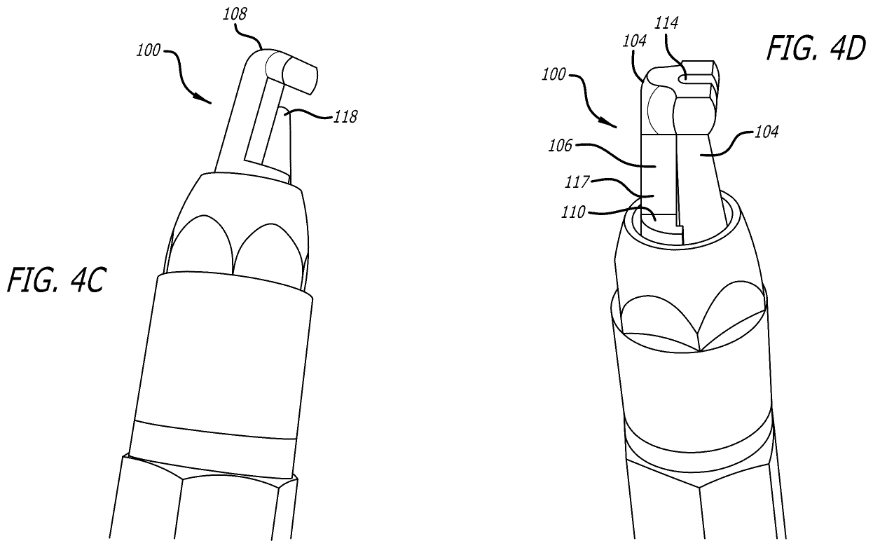

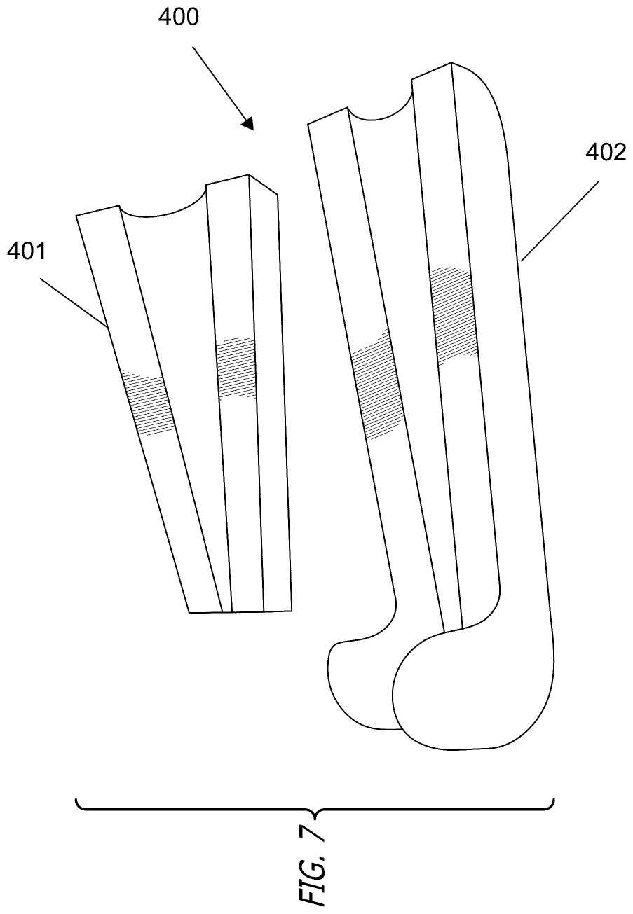

Turning next to FIG. 4A and continuing through FIG. 7, various geometries that improve over legacy contact tips will be discussed. To be clear: any embodiment with an improved geometry over legacy contact tips may include, but does not require, the coating materials discussed above, even if the example figure illustrates such a coating. The coating materials can be on both halves of the contact tip or only one half of the contact tip.

Four views of an open-tipped clamshell contact tip with an open end and side portions are depicted in FIG. 4A through FIG. 4D in accordance with an embodiment. FIG. 4A and FIG. 4B depict an open-tipped clamshell contact tip in an unassembled state. FIG. 4C and FIG. 4D depict the open-tipped clamshell contact tip in an assembled state. An open-tipped clamshell contact tip 100 can be formed from a guide portion 102 and an inset portion 104 coupled together. The guide portion 102 can include an elongated part 106. The elongated part 106 can be integrated, at a first end, with a guide terminal part 108. The elongated part 106 can be integrated, at a second (or opposite) end, with a guide proximal part 110. The elongated part 106 can have a longitudinal axis that is parallel (coaxial) with a wire path 112.

The guide terminal part 108 can have a terminal groove 114. The terminal groove 114 can have a protrusion on each side and can be configured such that a wire can pass between the protrusions in the terminal groove 114. The terminal groove 114 is aligned (substantially coaxial) with the wire path 112. The guide terminal part 108 can be wider than the elongated part 106.

The guide proximal part 110 can have a portion with a width greater than the width of the elongated part 106. Furthermore, the guide proximal part 110 and the terminal part 108 can both have a thickness (where the thickness can be orthogonal to the longitudinal direction and orthogonal to the width) that is larger than the thickness of the elongated part 106. The guide proximal part 110 can have a guide open portion 116 that lies along the wire path 112. The guide open portion 116 can accommodate a wire. The wires referenced can be wires suitable for WAAM. The wires can be made of metal alloys, aluminum alloys (see, e.g., U.S. patent application Ser. No. 17/929,558 filed Sep. 2, 2022, the disclosure of which is incorporated by reference).

In some embodiments, at least some of the guide portion 102 and/or at least some of the inset portion 104 can have a coating, e.g., a ceramic coating such as boron nitride or another suitable ceramic, as noted above. Boron nitride coatings can be beneficial to provide a heat resistant and electrically insulating coating. The partially coated guide portion 102 and inset portion 104 are shown in FIG. 4A and FIG. 4B. In some embodiments, the open-tipped clamshell contact tip 100 is not coated, as shown in FIG. 4C and FIG. 4D.

The elongated part 106, the guide terminal part 108, and the guide proximal part 110 can be configured to define first and second cutouts 117. The cutouts 117 can be bounded on each end by the guide terminal part 108 and the guide proximal part 110. The cutouts 117 can extend longitudinally, parallel with the elongated part 106. The cutouts 117 can be configured such that when the open-tipped clamshell contact tip 100 is assembled, the cutouts 117 permit wire shavings to pass through the cutouts 117. One or more openings in assembled contact tips can be configured to discharge wire shavings generated during WAAM.

The inset portion 104 can have an inset terminal part 118 and an inset proximal part 120. The inset terminal part 118 can be around the same width as the elongated part 106. When assembled, the guide proximal part 110 aligns and/or mates with the inset proximal part 120. The length of the inset portion 104 can be shorter than the corresponding guide portion 102. Hence, the inset portion can have a terminal part 118 that generally aligns with the end 121 of the elongated part 106.

Compared with the inset distal part of inset portion 311 in FIG. 3, the tip of inset terminal part 118 in FIGS. 4A and 4B is trimmed back around 3 mm. When the guide portion 102 and the inset portion 104 are coupled together, the trimmed back inset terminal part 118 (at a terminal end of the inset portion 104) forms a gap between a terminal end of the guide portion 102. In some embodiments, the gap can facilitate removal of the material buildups in the contact tips. In some embodiments, the gap and the cutouts can facilitate removal of the material buildups in the contact tips. Although the tip of inset distal part 118 in FIGS. 4A and 4B is trimmed back about 3 mm, as can be readily appreciated, a trimmed back length of less than about 3 mm, or greater than about 3 mm can be implemented as appropriate to the requirements of specific applications in accordance with various embodiments of the invention.

In several embodiments, the guide portion 102 and inset portion 104 can be nested to form an assembled contact tip 100 capable of holding a WAAM wire. The inset portion 104 is configured to align and/or assemble with the guide portion 102 to form an open-tipped clamshell contact tip 100 capable of holding a wire suitable for WAAM. Holding the wire can require keeping the wire in electrical communication with the open-tipped clamshell contact tip 100 while allowing the wire to be advanced in accordance with the requirements for WAAM. When the open-tipped clamshell contact tip 100 is assembled, the inset proximal part 120 can be in contact with the guide proximal part 110. As discussed above, the tip of inset terminal part 118 can be trimmed back (relative to the configuration in FIG. 3). In this example, the trim-back amount is sufficient to allow the tip of the inset terminal part 118 to be generally aligned with the terminal end of the elongated part 106 when the open-tipped clamshell contact tip 100 is assembled for use. The difference between the guide portion 102 and inset portion 104 lengths can be beneficial because the difference causes a gap when these portions are assembled, and this gap provides a path for wire shavings, material buildups, and/or other unwanted material to exit the assembled, open-tipped contact tip 100 during WAAM.

The assembled open-tipped clamshell contact tip 100 can have cut-out portions corresponding to the elongated part 106. The cut-out portions 117 can allow the open-tipped clamshell contact tip 100 to be cleaned without removing the contact tip from the print head and separating the inset portion 104 from the guide portion 102. The open-tipped clamshell contact tip 100 can be cleaned using compressed air and/or other suitable methods while the contact tip is still assembled.

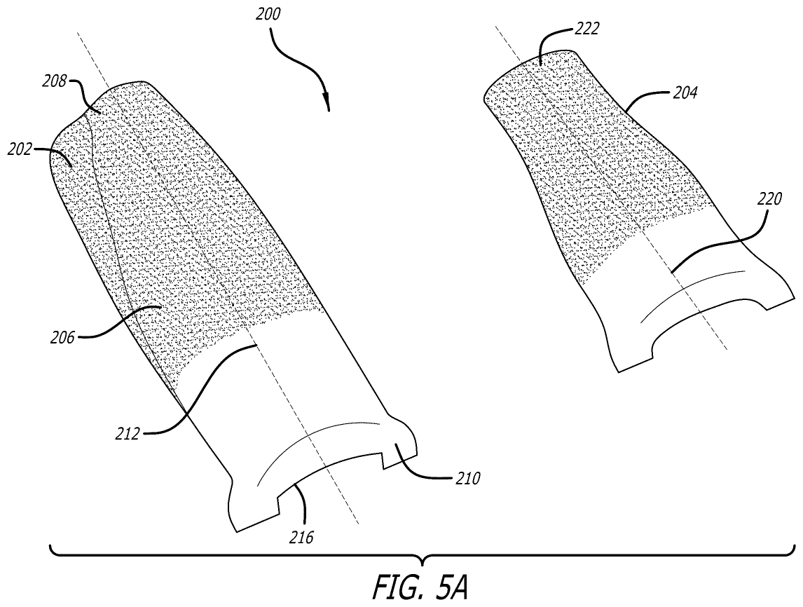

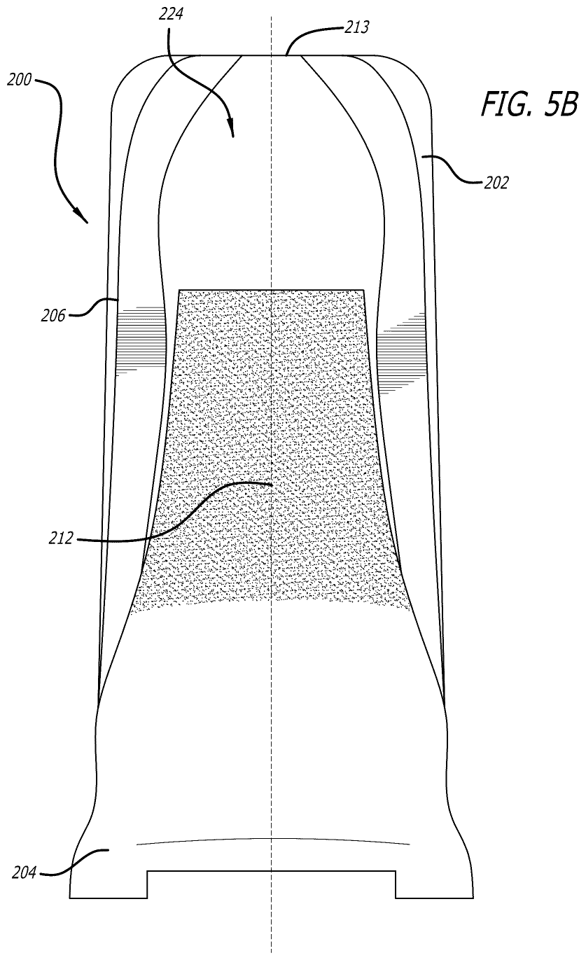

An open-tipped clamshell contact tip with a single face open end is depicted in FIG. 5A in accordance with an embodiment. An open-tipped clamshell contact tip 200 can have a guide portion 202 and an inset portion 204. The guide portion 202 can include a U-shaped part 206. The U-shaped part 206 can be integrated, at a first end, with a guide terminal part 208. The U-shaped part 206 can be integrated, at a second (or opposite) end, with a guide proximal part 210. The U-shaped part 206 can have a longitudinal axis that is parallel (coaxial) with a wire path 212. The guide terminal part 208 can have a terminal groove 213 (shown in FIG. 5B). The terminal groove 213 can be configured to support a wire. The terminal groove 213 can be aligned with the wire path 212. The terminal groove can be arranged at the tip of the guide portion 202. A guide proximal part 210 can have a guide open portion 216 that lies along the wire path 212. The guide open portion 216 can accommodate a wire. The wires referenced can be wires suitable for WAAM. The guide portion 202 and/or inset portion 204 can, in several embodiments, have a coating, such as boron nitride. As noted above, boron nitride coatings can be beneficial to provide a heat resistant and electrically insulating coating.

The inset portion 204 is capable of aligning and/or assembling with the guide portion 202 to form an open-tipped clamshell contact tip 200 capable of holding a wire suitable for WAAM. Holding the wire can require keeping the wire in electrical communication with the open-tipped clamshell contact tip 200 while allowing the wire to be advanced in accordance with the requirements for WAAM (e.g., in accordance with the requirement for robotic WAAM).

When the open-tipped clamshell contact tip 200 is assembled, an inset proximal part 220 can be in contact with the guide proximal part 210. The assembled open-tipped clamshell contact tip can have the tip of an inset distal part 222 generally aligned with an end of the U-shaped part 206. Compared with the inset distal part of inset portion 311 in FIG. 3, the tip of inset distal part 222 in FIGS. 5A and 5B is trimmed back around 3 mm. Although the tip of inset distal part 222 in FIGS. 5A and 5B is trimmed back about 3 mm, as can be readily appreciated, a trimmed back length of less than about 3 mm, or greater than about 3 mm can be implemented as appropriate to the requirements of specific applications in accordance with various embodiments of the invention. In various embodiments, the end of inset portion 204 can be around 4.75 mm shorter than the end of guide portion 202. Although a difference of about 4.75 mm between the inset portion 204 and the guide portion 202 is shown in FIGS. 5A and 5B, as can be readily appreciated, any of a length difference, such as less than about 5 mm, or less than about 4.75 mm, or greater than about 4.75 mm, or greater than about 5 mm can be implemented as appropriate to the requirements of specific applications in accordance with various embodiments of the invention.

FIG. 5B depicts the open-tipped clamshell contact tip 200 in an assembled configuration in accordance with an embodiment. Similarly contact tip 200 can be assembled by coupling the inset portion 204 into the guide portion 202. When assembled, the contact tip 200 can have a gap between a terminal end of the inset portion and a terminal end of the guide portion. As assembled, the contact tip 200 includes a shavings discharge opening 224 created by the trimmed back inset distal part 222. In various embodiments the shavings discharge opening is oriented towards the ground (floor) during operation. In this way, wire shavings produced during WAAM can fall out of the contact tip 200 using the effect of gravity. This can be beneficial to reduce buildup of wire shavings leading to a contact tip 200 failure. In some embodiments, contact tip 200 can achieve run time of about 6 hours, or up to 6 hours or thereabout, prior to failure. Longer and shorter run times are within the scope of the invention, such as up to about 1.5 hours, up to about 3 hours, and up to about 8 hours. Longevity of the contact tip can depend on thickness of the printed part. For example, a part having a thickness of about 0.550 inch to about 1 inch may result the contact tip of FIGS. 5A and 5B having a lifetime in the range of about 3 hours to about 6 hours, inclusive of the endpoints. A part having a lower thickness, such as about 0.300 inch, may result in the contact tip having a longer lifetime in the range of about 6 hours to about 8 hours, inclusive of the endpoints. Accordingly, longer or shorter lifetimes may depend on the thickness of the printed part and within the scope of the invention.

The assembled contact tip can include a shavings discharge opening. In accordance with some embodiments, a shavings discharge opening can be around 3 mm long; or less than about 3 mm; or greater than about 3 mm. Discharge openings can, in some embodiments have a single open face such that shavings discharge in a first direction. In many embodiments discharge openings can have three open faces. Discharge openings with three open faces can discharge wire shavings in a first, second, and/or third direction. Discharge openings with three open faces can be advantageous by allowing wire shavings to exit (by gravity) a contact tip while the contact tip assumes a variety of positions and not merely straight down.

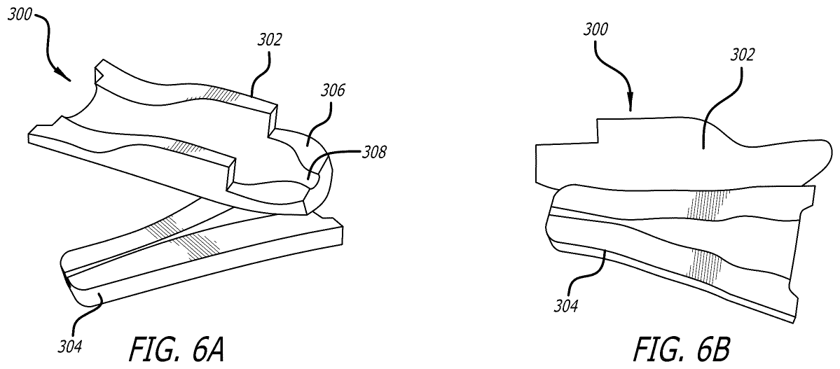

Two views of an open-tipped clamshell contact tip with two open faces at an end are depicted in FIG. 6A and FIG. 6B in accordance with an embodiment. The open-tipped clamshell contact tip 300 is similar in several respects to the contact tip 100 and the contact tip 200. The contact tip 300 has a generally semi-cylindrical guide portion 302. An inset portion 304 can be configured to form an assembled contact tip when coupled to the guide portion 302. The guide portion 302 further includes a shortened sidewall 306 to each side of a wire guide 308. The wire guide 308 is disposed on the guide portion 302. Once assembled the contact tip 300 can shed wire shavings through an opening formed by the shortened sidewall 306. Two openings can be located opposite one another in an assembled contact tip 300. As described elsewhere herein, openings in the assembled contact tip can beneficially extend the useable life of contact tips used for WAAM processes.

Various embodiments of the invention have been manufactured and or tested. FIG. 7 illustrates a contact tip in accordance with an embodiment. The inset portion 401 of the clamshell assembly is removed by about 3 mm from the tip as shown in FIG. 7. In this regard, the tip of the inset portion 401 in FIG. 7 has been modified in the same way as the tip of inset distal part 222 in FIGS. 5A and 5B. In FIG. 7, however, the guide portion 402 of the clamshell is further modified from the embodiment shown in FIGS. 5A and 5B, such that the guide portion 402 has the side walls configured so that the surface that the wire comes in contact with is substantially flat, except for the wire groove extending along the longitudinal axis. With this configuration, the contact tip 400 can achieve run time of at least 7 hours; or from about 7 hours to about 14 hours. An example run time lasts about 11 hours before contact tip failure. Longer run times are within the scope of the invention. The inventors observed that the gap formed between the insert portion 401 and the guide portion 402 facilitates material shavings falling out of the contact tip.

In many embodiments, the open tip contact tip can be attached to a print head for additive manufacturing processes. The print head can be a welding torch, metal inert gas (MIG) torch, and/or a tungsten inert gas (TIG) torch. As can readily be appreciated, any of a variety of print heads or welding torches can be utilized as appropriate to the requirements of specific applications in accordance with various embodiments of the invention. The print head can hold the contact tip, and a feed wire can be fed through the contact tip. The print head can be attached to an end effector of a robotic arm and/or a gantry that is suitable for additive manufacturing processes. In some embodiments, the additive manufacturing processes can be WAAM processes.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive. Notably, all references to WAAM in this application are provided as an example and should not be construed as limiting. Appropriate feedstocks include wire. Relevant energy sources are plasma, arc, laser, and others.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A contact tip for an additive manufacturing system, the contact tip comprising:
a guide portion, wherein the guide portion comprises:
an elongated portion with a first end and a second end; and
a guide terminal part attached to the first end of the elongated portion with a terminal groove, wherein the terminal groove is formed between two protrusions, and wherein the terminal groove is configured to accommodate a wire; and
an inset portion, wherein the inset portion is configured to nest within the guide portion to hold the wire,
wherein, when the inset portion is nested within the guide portion, there is a gap between a terminal end of the guide portion and a terminal end of the inset portion such that a material buildup inside the contact tip discharges through the gap.

2. The contact tip of claim 1, wherein the gap has at least one dimension equal to or greater than 3 mm.

3. The contact tip of claim 1, wherein the elongated portion has reduced heights on at least a portion of a first side and a second side such that when the inset portion is nested within the guide portion, there is a second gap and a third gap between the guide portion and the inset portion on the first side and the second side respectively, wherein the second gap and the third gap are configured to discharge the material buildup inside the contact tip.

4. The contact tip of claim 1, wherein at least a portion of the inset portion is coated with a ceramic material.

5. The contact tip of claim 1, wherein at least a portion of the guide portion is coated with a ceramic material.

6. The contact tip of claim 1, wherein at least a portion of the inset portion and at least a portion of the guide portion each is coated with a ceramic material.

7. The contact tip of claim 6, wherein the ceramic material comprises boron nitride.

8. The contact tip of claim 1, wherein the elongated portion has at least one cutout, wherein the at least one cutout is configured to discharge the material buildup inside the contact tip.

9. The contact tip of claim 1, wherein the material buildup inside the contact tip comprises at least one of: a plurality of wire shavings, a molten wire splatter.

10. The contact tip of claim 1, wherein the contact tip is configured to couple with a weld torch, a metal inert gas (MIG) torch, or a tungsten inert gas (TIG) torch.

11. The contact tip of claim 1, wherein the wire aligns coaxially with the terminal groove.

12. The contact tip of claim 1, wherein the contact tip comprises a material of a higher melting temperature than the wire.

13. The contact tip of claim 1, wherein the contact tip is configured to print a part continuously for at least 3 hours.

14. The contact tip of claim 13, wherein the part has at least one dimension of 0.55 inch and printing the part occurs continuously from 3 hours to 6 hours; or wherein the part has at least one dimension of 0.3 inch and printing the part occurs continuously from 6 hours to 8 hours.

15. A contact tip for feeding a wire, the contact tip comprising:
a first opening for admitting the wire into the contact tip, wherein the first opening lays along a longitudinal axis that is coaxial with a wire path of the wire;
a second opening for emitting a first portion of the wire from the contact tip, wherein the second opening lays along the longitudinal axis that is coaxial with the wire path of the wire; and
a third opening for emitting a second portion of the wire from the contact tip, wherein the third opening is set apart from the longitudinal axis that is coaxial with the wire path of the wire.

16. The contact tip of claim 15, further comprising a fourth opening for emitting a third portion of the wire from the contact tip, wherein the fourth opening is set apart from the longitudinal axis that is coaxial with the wire path of the wire.

17. The contact tip of claim 15, wherein at least a portion of the contact tip comprises a ceramic coating.

18. The contact tip of claim 15, wherein the second portion of the wire comprises a plurality of wire shavings.

19. A contact tip for feeding a wire, the contact tip comprising:
a first opening for admitting the wire into the contact tip, wherein the first opening lays along a longitudinal axis that is coaxial with a wire path of the wire; and
a second opening for emitting the wire and a plurality of wire shavings of the wire from the contact tip, wherein a first wire-emitting region of the second opening lays along the longitudinal axis that is coaxial with the wire path of the wire, and wherein a second wire shavings-emitting region of the second opening is set apart from the longitudinal axis that is coaxial with the wire path of the wire.

20. The contact tip of claim 19, further comprising a third opening for emitting the plurality of wire shavings of the wire from the contact tip, wherein the third opening is set apart from the longitudinal axis that is coaxial with the wire path of the wire.
